(19) United States
(12) Patent Application Publication
(10) Pub. No.: US 2008/0263395 A1
(43) Pub. Date: Oct. 23, 2008

(54) EMBEDDED DEVICE AND IMAGE LOADING METHOD THEREOF

(75) Inventor: IRAWAN KUNCORO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/051,854

(22) Filed: Mar. 20, 2008

(30) Foreign Application Priority Data
Apr. 20, 2007 (CN) 200710200492.9

(51) Int. Cl. G06F 11/07; G06F 17/30

(52) U.S. Cl. 714/15; 707/204; 714/E11.023; 707/E17.044

(57) ABSTRACT

An embedded device (10) includes an image module (11) and an image invoking module (13). The image module for storing all working images of an operating system of the embedded device includes an image sharing sub-module (110), an application image sub-module (111), and an application image backup sub-module (112). The image sharing sub-module is used for storing a kernel image, a library image, and a driver image. The application image sub-module is used for storing a user application image. The application image backup sub-module is used for backing up the user application image. The image invoking module is used for invoking and running the kernel images, the library image, and the driver image.

### BACKGROUND

1. Field of the Invention

The invention relates to embedded devices, and particularly to an embedded device and image loading method thereof.

2. Description of Related Art

With the growing popularity of the Linux system, more and more attention is being paid to the Linux system. The Linux system includes a working image module that includes non-user-application images, i.e., a kernel image, a library image, a driver image, etc., and a user application image. The Linux system also includes a working image backup module, which is used for backing up images of the working image module. The user application image is damaged easily in a process of loading the Linux system.

In the process of loading the Linux system, when invoking and running all images of the working image module, if the user application image is damaged, the Linux system invokes and runs all backed up images of the working image backup module, for example, invoking and running the backed up kernel image, the backed up library image, the backed up driver image, and the backed up user application image. Cost of a flash memory for storing the kernel image, the library image, and the driver image is high, because of the capacity needed for storing the kernel image, the library image, and the driver image.

### SUMMARY

One aspect of the invention provides an embedded device. The embedded device includes an image module and an image invoking module. The image module is used for storing all working images of an operating system of the embedded device, and includes an image sharing sub-module, an application image sub-module, and an application image backup sub-module. The image sharing sub-module is used for storing all non-user-application images including a kernel image, a library image, and a driver image. The application image sub-module is used for storing a user application image. The application image backup sub-module is used for backing up the user application image. The image invoking module is used for invoking and running the kernel image, the library image, and the driver image.

Other advantages and novel features will become more apparent from the following detailed description when taken in conjunction with the accompanying drawings, in which:

### BRIEF DESCRIPTION OF THE DRAWINGS

FIG. 1 is a block diagram of a an embedded device in accordance with an exemplary embodiment of the invention; and

FIG. 2 is a flow chart of an image loading method of the embedded device in accordance with a another exemplary embodiment of the invention.

### DETAILED DESCRIPTION OF THE EMBODIMENTS

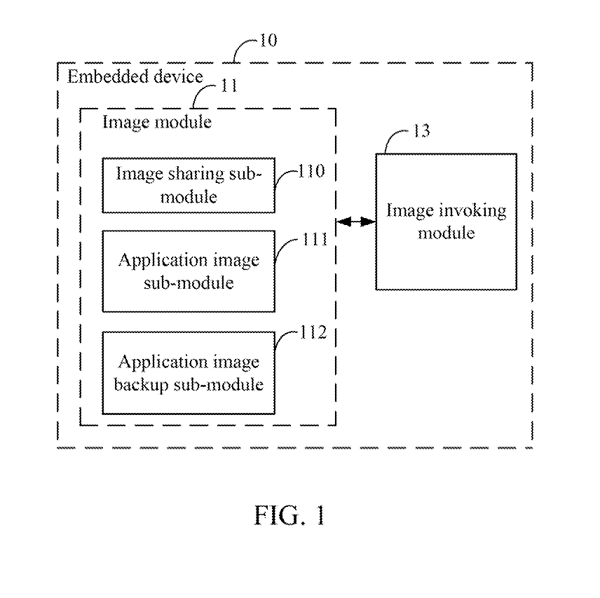

FIG. 1 is a block diagram of an embedded device 10 in accordance with an exemplary embodiment of the invention. In the exemplary embodiment, the embedded device 10 operates with an operation system, such as the Linux system, or the Windows NT system.

In the exemplary embodiment, the embedded device 10 includes an image module 11. The image module 11 is used for storing all working images of the operating system employed by the embedded device 10, and includes an image sharing sub-module 110, an application image sub-module 111, and an application image backup sub-module 112. In the exemplary embodiment, the working images stored in the image module 11 include, but are not limited to, non-user-application images, i.e., a kernel image, a library image, a driver image, etc., and a user application image. In the exemplary embodiment, the image module 11 may be a flash type memory device.

In the exemplary embodiment, the image sharing sub-module 110 is used for storing the kernel image, the library image, and the driver image. The application image sub-module 111 is used for storing the user application image. The application image backup sub-module 112 is used for backing up the user application image.

In the exemplary embodiment, the embedded system 10 further includes an image invoking module 13. The image invoking module 13 communicates with the image sharing sub-module 110, the application image sub-module 111, and the backup application image sub-image 112, and is used for invoking and running the kernel image, the library image, and the driver image when loading the Linux system.

In the exemplary embodiment, the kernel image is used for determining whether the user application image of the application image sub-module 111 is damaged. The image invoking module 13 is further used for invoking the user application image or the backed up user application image according to whether the user application image is damaged or not. If the kernel image determines the user application image of the application image sub-module 111 is damaged, the kernel image sends a command for invoking the backed up user application image to the image invoking module 13. In the exemplary embodiment, the image invoking module 13 receives the command for invoking the backed up user application image sent by the kernel image, and invokes and runs the backed up user application image stored in the application image backup sub-module 112.

In the exemplary embodiment, if the kernel image determines the user application image of the application image sub-module 111 is not damaged, the kernel image sends a command for invoking the user application image to the image invoking module 13. The image invoking module 13 receives the command for invoking the user application image sent by the kernel image, and invokes and runs the user application image stored in the application image sub-module 111. In the exemplary embodiment, the kernel image determines whether the user application image of the application image sub-module 111 is damaged via sending a detecting signal to the application image sub-module 111.

In the exemplary embodiment, the kernel image is further used for determining whether the user application image stored in the application image sub-module 111 needs to be upgraded. If the kernel image determines the user application image stored in the application image sub-module 111 needs to be upgraded, the kernel image downloads a new user application image, and upgrades the user application image stored in the application image sub-module 111.

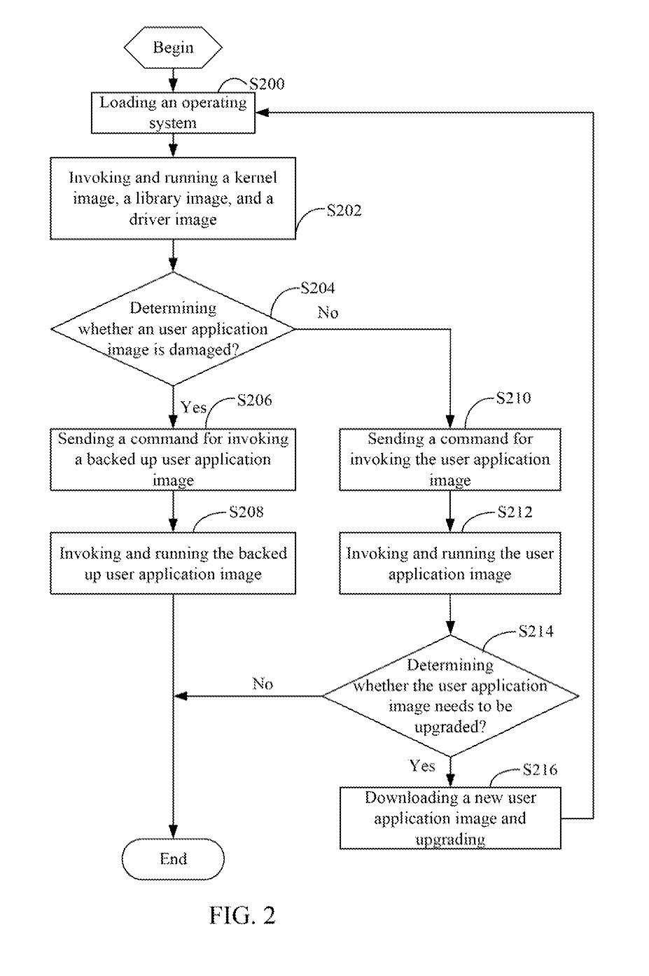

FIG. 2 shows a flow chart of an image loading method of the embedded device 10 in accordance with an exemplary embodiment of the invention. In the exemplary embodiment, when the embedded device 10 loads the operating system, at first, the image invoking module 13 invokes and runs the kernel image, the library image, and the driver image stored in the image sharing sub-module 110, and then invokes and runs the user application image stored in the application image sub-module 111 or in the application image backup sub-module 112. In step S200, the embedded device 10 loads the operating system of the embedded device 10.

In step S202, the image invoking module 13 invokes and runs the kernel image, the library image, and the driver image stored in the image sharing sub-module 110.

In step S204, the kernel image determines whether the user application image of the application image sub-module 111 is damaged, after the kernel image, the library image, and the driver image have all been invoked and ran. In the exemplary embodiment, the kernel image determines whether the user application image of the application image sub-module 111 is damaged via sending a detecting signal to the application image sub-module 111.

If the kernel image determines the user application image stored in the application image sub-module 111 is damaged, the procedure turns to step S206, the kernel image sends a command for invoking backed up user application image to the image invoking module 13.

In step S208, the image invoking module 13 invokes and runs the backed up user application image stored in the backup application image module 112.

If the kernel image determines the user application image stored in the application image sub-module 111 is not damaged, the procedure turns to step S210, the kernel image sends a command for invoking the user application image to the image invoking module 13.

In step S212, the image invoking module 13 invokes and runs the user application image stored in the application image sub-module 111.

In step S214, the kernel image determines whether the user application image stored in the application image sub-module 111 needs to be upgraded.

If the kernel image determines the user application image stored in the application image sub-module 111 needs to be upgraded, the procedure turns to step S216, the kernel image downloads a new user application image, upgrades the user application image stored in the application image sub-module 111, and then the procedure returns back to step S200.

If the kernel image determines the user application image stored in the application image module 111 does not to be upgraded, the procedure completes.

The embedded device 10 and the loading method of the embedded device 10 decreases the amount of storage capacity needed thus reducing the cost of backing up the kernel image, the library image, and the driver image, and only invokes and runs the backup user application image when the user application image is damaged in the process of the loading the Linux system, and does not have to invoke and run the kernel image, the library image, and the driver image once again.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. An embedded device, comprising:
an image module, for storing all working images of an operating system of the embedded device, comprising:
an image sharing sub-module, for storing a kernel image, a library image, and a driver image;
an application image sub-module, for storing a user application image; and
an application image backup sub-module, for backing up the user application image; and
an image invoking module, for invoking and running the kernel image, the library image, and the driver image stored in the image sharing sub-module.

2. The embedded device of claim 1, wherein the kernel image is used for determining whether the user application image of the application image sub-module is damaged.

3. The embedded device of claim 2, wherein the image invoking module is further used for invoking the user application image or a backed up user application image according to a result of determining whether the user application image of the application image sub-module is damaged.

4. The embedded device of claim 3, wherein the kernel image is further used for sending a command for invoking the backed up user application image to the image invoking module if the user application image of the application image sub-module is damaged.

5. The embedded device of claim 4, wherein the image invoking module is further used for receiving the command for invoking the backed up user application image sent by the kernel image, and invoking and running the backed up user application image from the application image backup sub-module.

6. The embedded device of claim 3, wherein the kernel image is further used for sending a command for invoking the user application image to the image invoking module if the user application image of the application image sub-module is not damaged.

7. The embedded device of claim 6, wherein the image invoking module is further used for receiving the command for invoking the user application image sent by the kernel image, and invoking and running the user application image from the application image sub-module.

8. The embedded device of claim 2, wherein the kernel image determines whether the user application image in the application image sub-module is damaged via sending a detecting signal to the application image sub-module.

9. The embedded device of claim 1, wherein the kernel image is used for determining whether the user application image of the application image sub-module needs to be upgraded.

10. The embedded device of claim 9, wherein the kernel image is further used for downloading a new user application image, and upgrading the user application image of the application image sub-module if the user application image needs to be upgraded.

11. An image loading method of an embedded device, comprising the steps of:
loading an operating system of the embedded device;
invoking and running a kernel image, a library image, and a driver image in an image sharing sub-module;
determining whether a user application image in an application image sub-module is damaged;
if damaged, sending a command for invoking a backed up user application image to an image invoking module; and
invoking and running a backed up user application image in an application image backup sub-module.

12. The image loading method of claim 11, further comprising the steps of:
sending a command for invoking the user application image to the image invoking module, if the user application image is not damaged; and
invoking and running the user application image in the application image sub-module.

13. The image loading method of claim 12, further comprising the steps of:
determining whether the user application image of the application image sub-module needs to be upgraded;
downloading a new user application image if the user application image of the application image sub-module needs to be upgraded; and
upgrading the user application image as the new user application image.

14. The image loading method of claim 12, wherein the step of determining whether the user application image of an application image sub-module is damaged further comprises the step of:
sending a detecting signal to the application image sub-module to determine whether the user application image in the application image sub-module is damaged.

15. A method of loading images for an embedded device, comprising:
loading an operating system of said embedded device;
invoking and running non-user-application images stored in a first sub-module;
invoking and running at least one user application image stored in a second sub-module different from said first sub-module when said user application image is determined not to be damaged; and
invoking and running at least one backed up user application image stored in a backup sub-module different from said first and second sub-modules when said user application image is determined to be damaged.

16. The method of claim 15, further comprising:
downloading a new user application image when said user application image storing in said second sub-module needs to be upgraded; and
upgrading said user application image by said new user application image.
